(19) United States
(12) Patent Application Publication
(10) Pub. No.: US 2019/0196082 A1
(43) Pub. Date: Jun. 27, 2019

(54) DISPLAY DEVICE HAVING A LIGHT GUIDE PLATE WITH A CURVED SIDE SURFACE

(71) Applicant: SAMSUNG DISPLAY CO., LTD., YONGIN-SI (KR)

(72) Inventors: WEEJOON JEONG, SEONGNAM-SI (KR); MINGWAN HYUN, YONGIN-SI (KR)

(21) Appl. No.: 16/183,202

(22) Filed: Nov. 7, 2018

(30) Foreign Application Priority Data
Dec. 27, 2017 (KR) 10-2017-0180751

(51) Int. Cl. F21V 8/00

(52) U.S. Cl. CPC G02B 6/002; G02B 6/0065

(57) ABSTRACT

A display device includes a curved display panel, a light source configured to emit a light, and a curved light guide plate having a curvature corresponding to a curvature of the curved display panel and configured to emit the light incident from the light source to the curved display panel. The curved display panel, the light source, and the curved light guide plate are disposed in a first direction. The curved light guide plate includes a side surface which protrudes in a direction substantially perpendicular to the first direction. The side surface protrudes away from an upper surface of the curved light guide plate toward a central portion of the curved light guide plate. The side surface has a protruding distance proportional to the curvature of the curved light guide plate.

### CROSS-REFERENCE TO RELATED APPLICATION

This application claims priority under 35 U.S.C. § 119 to Korean Patent Application No. 10-2017-0180751, filed on Dec. 27, 2017 in the Korean Intellectual Property Office (KIPO), the disclosure of which is incorporated by reference herein in its entirety.

### TECHNICAL FIELD

Exemplary embodiments of the inventive concept relate to a display device, and more particularly, to display device in which a side surface of a light guide plate is curvedly formed so as to substantially prevent deformation of the light guide plate.

### DISCUSSION OF RELATED ART

In general, liquid crystal display (“LCD”) devices include a display panel which includes a liquid crystal layer and a backlight unit. The backlight unit includes a light source for providing light to the display panel, a light guiding plate (LGP), and an optical sheet for diffusing or condensing the light provided from the light guide plate. The light guide plate is configured to supply the light provided from the light source unit uniformly to the display panel.

To form conventional light guide plates, a resin based on methyl methacrylate-styrene (“MS”) or polymethyl methacrylate (“PMMA”) may be used. However, when heat is generated in the display device because, for example, the display device is used for a relatively long time, the light guide plate may be deformed, thus causing a problem. In addition, when a light dissipation space is provided to dissipate the heat that affects the light guide plate, the overall thickness of the display device may increase.

Meanwhile, display devices employing quantum dots (“QDs”) include a quantum dot sheet or a quantum dot film on the light guide plate. When the light guide plate is deformed, the quantum dot sheet or the quantum dot film of the display device is inferior in color. Further, when the light guide plate and the backlight unit including a light emitting diode (“LED”) are spaced apart from each other by a sufficient distance to solve this problem, the overall thickness of the display device may increase.

A glass light guide plate is used in quantum dot display devices because glass is resistant to heat deformation and the thickness of the display device may be greatly reduced by using a glass material.

Curved display devices, e.g., televisions, have improved stereoscopic effects to enhance viewers' sense of immersion. When a glass light guide plate is employed in such curved display devices, the glass light guide plate is vulnerable to shear stress, and thus the glass light guide plate may be broken because of micro cracks that occur at a side surface portion thereof.

### SUMMARY

According to an exemplary embodiment of the inventive concept, a display device includes a curved display panel, a light source configured to emit a light, and a curved light guide plate having a curvature corresponding to a curvature of the curved display panel and configured to emit the light incident from the light source to the curved display panel. The curved display panel, the light source, and the curved light guide plate are disposed in a first direction. The curved light guide plate includes a side surface which protrudes in a direction substantially perpendicular to the first direction. The side surface protrudes away from an upper surface of the curved light guide plate toward a central portion of the curved light guide plate. The side surface has a protruding distance proportional to the curvature of the curved light guide plate.

A ratio of a radius of the curvature of the curved light guide plate to the protruding distance may be about 9000 or more and 42000 or less.

The curved light guide plate may be a glass light guide plate.

The side surface of the curved light guide plate may include one to four protruding side surfaces.

The side surface of the curved light guide plate may have a constant curvature.

The side surface of the curved light guide plate may have a variable curvature.

According to an exemplary embodiment of the inventive concept, a display device includes a curved display panel, a light source configured to emit a light, a light source substrate on which the light source is disposed, and a curved light guide plate having a curvature corresponding to a curvature of the curved display panel and configured to emit the light incident from the light source to the curved display panel. The curved display panel, the light source, the light source substrate, and the curved light guide plate are disposed in a first direction. The curved light guide plate includes a side surface which protrudes in a direction substantially perpendicular to the first direction. The side surface protrudes away from an upper surface of the curved light guide plate toward a central portion of the curved light guide plate. The side surface has a protruding distance proportional to the curvature of the curved light guide plate. The light source substrate has a curvature corresponding to the curvature of the curved light guide plate.

A ratio of a radius of the curvature of the curved light guide plate to the protruding distance may be about 9000 or more and 42000 or less.

The curved light guide plate may be a glass light guide plate.

The side surface of the curved light guide plate may include one to four protruding side surfaces.

The side surface of the curved light guide plate may have a constant curvature.

The side surface of the curved light guide plate may have a variable curvature.

According to an exemplary embodiment of the inventive concept, a display device includes a curved display panel, a light source configured to emit a light, a light source substrate on which the light source is disposed, and a curved light guide plate having a curvature corresponding to a curvature of the curved display panel and configured to emit the light incident from the light source to the curved display panel. The curved display panel, the light source, the light source substrate, and the curved light guide plate are disposed in a first direction. The curved light guide plate includes a side surface which protrudes in a direction substantially perpendicular to the first direction. The side surface protrudes away from an upper surface of the curved light guide plate toward a central portion of the curved light guide plate. The side surface has a protruding distance proportional to the curvature of the curved light guide plate. The light source substrate has an interfacial angle corresponding to the side surface of the curved light guide plate.

A ratio of a radius of the curvature of the curved light guide plate to the protruding distance may be about 9000 or more and 42000 or less.

The curved light guide plate may be a glass light guide plate.

The side surface of the curved light guide plate may include one to four protruding side surfaces.

The side surface of the curved light guide plate may have a constant curvature.

The side surface of the curved light guide plate may have a variable curvature.

According to an exemplary embodiment of the inventive concept, a curved light guide plate has a curvature corresponding to a curvature of a curved display panel, is configured to emit a light incident from a light source to the curved display panel, and includes a side surface which protrudes in a direction substantially perpendicular to a first direction. The curved light guide plate and the curved display panel are disposed in the first direction. The side surface protrudes away from an upper surface of the curved light guide plate toward a central portion of the curved light guide plate. The side surface has a protruding distance proportional to the curvature of the curved light guide plate.

A ratio of a radius of the curvature of the curved light guide plate to the protruding distance may be about 9000 or more and 42000 or less.

The curved light guide plate may be a glass light guide plate.

The side surface of the curved light guide plate may include one to four protruding side surfaces.

The side surface of the curved light guide plate may have a constant curvature.

The side surface of the curved light guide plate may have a variable curvature.

According to an exemplary embodiment of the inventive concept, in a method of forming a display device including a curved display panel and a light guide plate, the method includes processing the light guide plate to have a curvature corresponding to a curvature of the curved display panel, and processing a side surface of the light guide plate to have a curvature and protrude away from an upper surface of the light guide plate towards a central portion of the light guide plate. The side surface has a protruding distance proportional to the curvature of the light guide plate.

The light guide plate may be processed using a constant curvature method.

The method may further include processing an upper end portion and a lower end portion of the side surface to have a curvature. A radius of the curvature of the upper end portion and the lower end portion may be about 1/10 or less of a radius of the curvature of the side surface.

When the side surface of the light guide plate is processed to have a curvature, a chamfered area of the side surface may increase by about 5% or less of a planar area of the side surface.

A ratio of a radius of the curvature of the light guide plate to the protruding distance may be about 9000 or more and 42000 or less.

The light guide plate may be a glass light guide plate.

The side surface of the light guide plate may include one to four protruding side surfaces.

The side surface of the light guide plate may have a constant curvature.

The side surface of the light guide plate may have a variable curvature.

### BRIEF DESCRIPTION OF THE DRAWINGS

The above and other features of the inventive concept will become more apparent by describing in detail exemplary embodiments thereof with reference to the accompanying drawings.

FIGS. 1A and 1B are views illustrating a structure of a side surface of a light guide plate.

FIG. 2 is a view illustrating a part of a glass light guide plate having chamfered corners.

FIG. 3 is an exploded perspective view illustrating a display device including a glass light guide plate according to an exemplary embodiment of the inventive concept.

FIG. 4 is a cross-sectional view illustrating a backlight unit taken along line I-I′ of FIG. 3 according to an exemplary embodiment of the inventive concept.

FIG. 5 is a cross-sectional view schematically illustrating a display device according to an exemplary embodiment of the inventive concept.

FIG. 6 is a cross-sectional view schematically illustrating a display device according to an exemplary embodiment of the inventive concept.

FIG. 7 is a cross-sectional view illustrating a part of a glass light guide plate according to an exemplary embodiment of the inventive concept;

FIG. 8 is a cross-sectional view schematically illustrating a display device according to an exemplary embodiment of the inventive concept.

FIGS. 9A and 9B are views illustrating a stress distribution of the light guide plate before and after processing a side surface of the curved light guide plate according to an exemplary embodiment of the inventive concept.

FIG. 10 is a view illustrating the relationship between a shape of the processed side surface and methods of curving surfaces according to an exemplary embodiment of the inventive concept.

### DETAILED DESCRIPTION OF THE EMBODIMENTS

Exemplary embodiments of the inventive concept are directed to a display device in which a side surface of a light guide plate is curvedly formed to reduce cracks of the light guide plate and substantially prevent deformation of the light guide plate.

Exemplary embodiments of the inventive concept will now be described more fully hereinafter with reference to the accompanying drawings. Like reference numerals may refer to like elements throughout this application.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween.

“About” or “approximately” as used herein is inclusive of the stated value and means within an acceptable range of variation for the particular value as determined by one of ordinary skill in the art, considering the measurement in question and the error associated with measurement of the particular quantity (i.e., the limitations of the measurement system). For example, “about” may mean within one or more standard variations, or within ±30%, 20%, 10%, or 5% of the stated value.

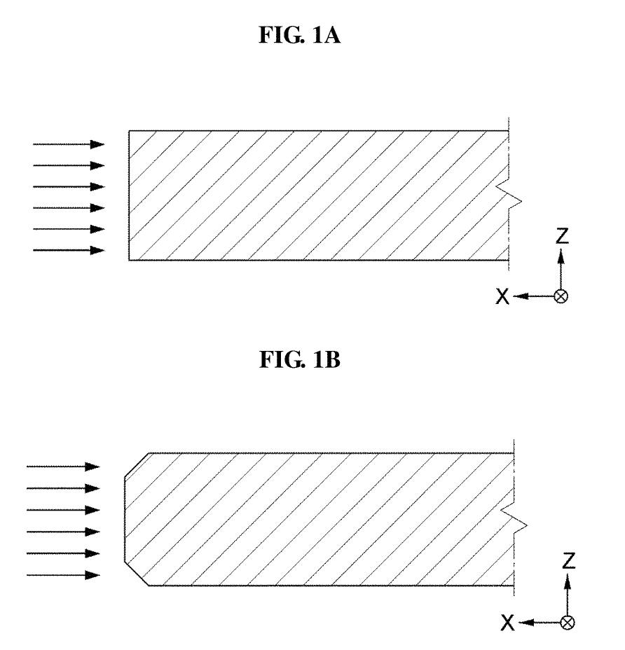

FIGS. 1A and 1B are views illustrating a structure of a side surface of a light guide plate.

Referring to FIG. 1A, a light guide plate including or formed of methyl methacrylate-styrene (“MS”) or polymethyl methacrylate (“PMMA”) has a flat side surface. Referring to FIG. 1B, a light guide plate including or formed of glass has chamfered corners so as to relieve stress concentrated at corners. As such, in the case where the corners are excessively chamfered, an amount of light incident to the light guide plate may be reduced.

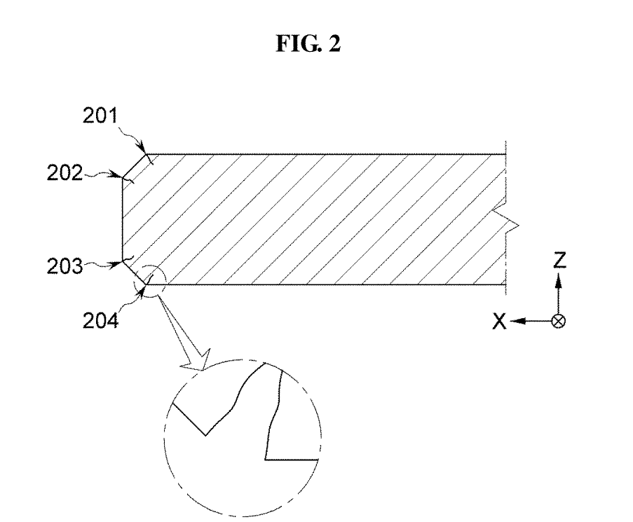

FIG. 2 is a view illustrating a part of a glass light guide plate having chamfered corners.

Referring to FIG. 2, corners 201, 202, 203, and 204 of the glass light guide plate are still susceptible to micro cracks due to large stresses. In particular, when the glass light guide plate has a certain curvature, the corner portions may be subjected to a larger stress, and the glass light guide plate may be damaged as the micro cracks are enlarged.

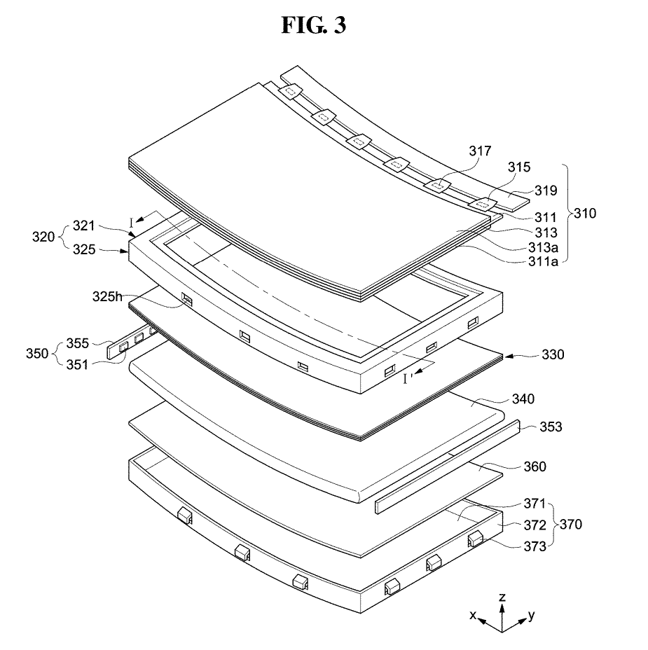

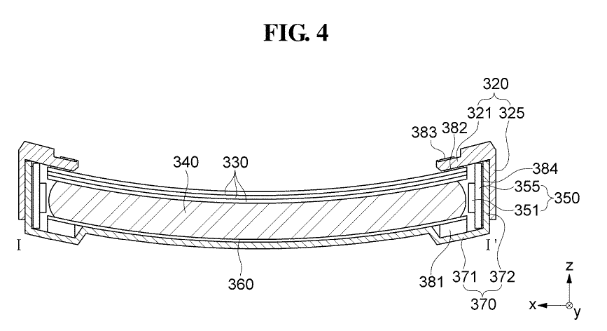

FIG. 3 is an exploded perspective view illustrating a display device including a glass light guide plate according to an exemplary embodiment of the inventive concept, and FIG. 4 is a cross-sectional view illustrating a backlight unit taken along line I-I′ of FIG. 3 according to an exemplary embodiment of the inventive concept.

Referring to FIGS. 3 and 4, the display device according to an exemplary embodiment of the inventive concept includes a display panel 310, a mold frame 320, an optical sheet 330, a light guide plate 340, a light source unit 350, a reflection sheet 360, a bottom chassis 370, and the like. Hereinafter, the mold frame 320, the optical sheet 330, the light guide plate 340, the light source unit 350, the reflection sheet 360, the bottom chassis 370, and the like are collectively referred to as a backlight unit.

The display panel 310 may be provided in a quadrangular plate shape and may receive an electric signal from the outside to display images. The display panel 310 may include a first substrate 311, a second substrate 313 opposing the first substrate 311, and a liquid crystal layer between the first substrate 311 and the second substrate 313.

The first substrate 311 may include a plurality of pixel electrodes arranged in a matrix, a thin film transistor applying a driving voltage to each of the pixel electrodes, and various signal lines for driving the pixel electrodes and the thin film transistor.

The second substrate 313 may include a common electrode and a color filter. The common electrode may include a transparent conductive material, and the color filter may include red, green, and blue color filters.

Although it is described that the first substrate 311 includes the pixel electrode, and the second substrate 313 includes the common electrode and the color filter, the inventive concept is not limited thereto. In an exemplary embodiment of the inventive concept, the common electrode may be formed on the first substrate 311, and the pixel electrode may be formed on the second substrate 313. In addition, the common electrode and the color filter may be formed on the first substrate 311. Moreover, the pixel electrode, the common electrode, and the color filter may be all formed on the first substrate 311.

The liquid crystal layer is interposed between the first substrate 311 and the second substrate 313, and is rearranged by an electric field formed between the pixel electrode and the common electrode. As such, the rearranged liquid crystal layer adjusts the transmittance of light emitted from the backlight unit, and the adjusted light passes through the color filter to display images outside the display panel 310.

In addition, a lower polarizer 311a may be further disposed on a back surface of the first substrate 311 and an upper polarizer 313a may be further disposed on an upper surface of the second substrate 313. The upper polarizer 313a may have a planar area corresponding to or less than a planar area of the second substrate 313 of the display panel 310. In addition, the lower polarizer 311a may have a planar area corresponding to or less than a planar area of the first substrate 311.

The upper polarizer 313a may transmit only a specific polarized light among light arriving from outside thereof to be incident thereto, and absorb or block the remaining light from the outside thereof. In addition, the upper polarizer 313a polarizes and emits the light that has emitted from the backlight unit and has passed through the liquid crystal layer.

The lower polarizer plate 311a may transmit only a specific polarized light among the light emitted from the backlight unit to be incident thereto, and absorb or block the remaining light from the backlight unit.

A driving circuit board 319 may be disposed on at least one side of the display panel 310. The driving circuit board 319 may apply various control signals and power signals for driving the display panel 310.

The display panel 310 and the driving circuit board 319 may be electrically connected to each other by at least one flexible printed circuit board (“FPCB”) 315. The FPCB 315 may be a chip on film (“COF”) or a tape carrier package (“TCP”), and the number of the FPCBs 315 may vary depending on the size and driving scheme of the display panel 310.

A driving chip 317 may be mounted on the FPCB 315. The driving chip 317 may generate various driving signals for driving the display panel 310. The driving chip 317 may be represented by a driver integrated circuit (“IC”) and/or a source IC in which a timing controller and a data driving circuit are integrated into one chip.

The display panel 310 has a predetermined radius of curvature. Two relatively long sides (hereinafter, “long sides”) of the display panel 310 may have concavely curved shapes with a constant curvature, and two relatively short sides (hereinafter, “short sides”) may have straight line shapes. Alternatively, the display panel 310 may have a structure in which the short sides may have concavely curved shapes with a constant curvature, and the long sides may have straight line shapes. Alternatively, the long sides and the short sides may each have a concavely curved shape with a predetermined curvature.

Referring to FIGS. 3 and 4, the display panel 310 has the long sides in an X-axis direction and the short sides in a Y-axis direction, and the display panel 310 is curved in the X-axis direction and is not curved in the Y-axis direction. In other words, the curved display panel 310 is curved in a longitudinal direction, and the curved display panel 310 has a straight line in a width direction.

The display panel 310 may include or be formed of a flexible material, and may be curved as it is disposed on the bottom chassis 370 and the mold frame 320. In other words, the bottom chassis 370 and the mold frame 320 fix the display panel 310 such that the display panel 310 has a predetermined radius of curvature.

Accordingly, the bottom chassis 370 and the mold frame 320, to be described below, have a predetermined radius of curvature in a form similar to that of the display panel 310. In addition, the optical sheet 330, the light guide plate 340, the reflection sheet 360, and the like disposed on the bottom chassis 370 also have a predetermined radius of curvature in a form similar to that of the bottom chassis 370. Thus, the display panel 310 has a predetermined non-zero curvature. The curvature is defined as the inverse of the radius of curvature R.

The display panel 310 may be curved in various ways. For example, when a direction in which the display panel 310 displays images is defined as an upward direction, and a direction opposite to the upward direction is defined as a downward direction, the display panel 310 may be curved convexly in the downward direction or in the upward direction. However, the curve direction of the display panel 310 is not limited thereto. For example, a central portion of the display panel 310 may be convex in the upward direction, e.g., convex to a user side. Alternatively, a part of the display panel 310 may be convex in the upward direction, and another part of the display panel 310 may also be convex in the upward direction.

The mold frame 320 supports an edge of a back surface of the display panel 310, and provides a space for accommodating therein the optical sheet 330, the light guide plate 340, the light source unit 350, the reflection sheet 360, or the like.

The mold frame 320 may have a polygonal frame shape in which a hollow space is defined. In an exemplary embodiment of the inventive concept, the mold frame 320 may have a quadrangular frame shape in which the hollow space is defined. The mold frame 320 may be formed into a single unitary member or may be formed as a plurality of separated pieces to be assembled to each other to form the frame shape.

Referring to FIGS. 3 and 4, the mold frame 320 may include a horizontal portion 321 on which the edge of the back surface of the display panel 310 is supported and a vertical portion 325 which extends substantially perpendicularly from the horizontal portion 321. The vertical portion 325 may have a coupling groove 325h with which a protrusion portion 373 of the bottom chassis 370, to be described below, is engaged.

An adhesive tape 383 may be disposed on an upper surface of the horizontal portion 321 of the mold frame 320 so as to couple the display panel 310 with the mold frame 320. In addition, an adhesive tape 382 may be disposed on a lower surface of the horizontal portion 321 of the mold frame 320 so as to couple the mold frame 320 with the optical sheet 330 and the light guide plate 340, to be described below. The adhesive tapes 382 and 383 may be a double-sided tape, and may be a black tape for substantially preventing light leakage.

The optical sheet 330 is disposed on the light guide plate 340 and serves to diffuse and/or collimate a light directed from the light guide plate 340. The optical sheet 330 may include a plurality of individual functional sheets such as a diffusion sheet, a prism sheet, and/or a protection sheet. The diffusion sheet, the prism sheet, and the protection sheet may be sequentially stacked on the light guide plate 340 in the order listed.

The prism sheet may collimate the light guided by the light guide plate 340, the diffusion sheet may diffuse the light collimated by the prism sheet, and the protection sheet may protect the prism sheet. A light passing through the protection sheet may be directed toward the display panel 310.

The light guide plate 340 may supply the light provided from the light source unit 350 uniformly to the display panel 310. The light guide plate 340 may be provided in a quadrangular plate shape, but the inventive concept is not limited thereto. When a light emitting diode (“LED”) chip is used as a light source, the light guide plate 340 may have various forms including predetermined grooves, protrusions, or the like depending on the position of the light source. The shape of the light guide plate 340 will be described further below.

The light guide plate 340 may include a light-transmissive material including, for example, glass, so as to guide light efficiently.

The light source unit 350 includes a light source 351 and a light source substrate 355 on which the light source 351 is disposed. The light source 351 may be disposed to oppose a light incidence surface of the light guide plate 340. In other words, the light source 351 may emit the light toward the light incidence surface of the light guide plate 340. The light source 351 may include at least one LED or an LED chip. For example, the light source 351 may be a gallium nitride (GaN)-based LED chip that emits blue light.

The number of the light sources 351 may vary in consideration of size and luminance uniformity of the display panel 310. The light source substrate 355 may be a printed circuit board (“PCB”) or a metal PCB.

The light source unit 350 may be disposed on one side surface, opposite side surfaces or all four side surfaces of the light guide plate 340 in consideration of the size and luminance uniformity of the display panel 310. In other words, the light source unit 350 may be disposed or formed on at least one edge portion of the light guide plate 340.

A wavelength converter may be disposed between the light source unit 350 and the light guide plate 340. The wavelength converter may include a material for converting the wavelength of light. In an exemplary embodiment of the inventive concept, the wavelength converter may convert a wavelength of blue light emitted from a blue LED light source into white light.

The reflection sheet 360 may include, for example, polyethylene terephthalate (PET), thus having reflectivity. One surface of the reflection sheet 360 may be coated with a diffusion layer including, for example, titanium dioxide. In addition, the reflection sheet 360 may include a material including a metal such as silver (Ag).

The bottom chassis 370 is coupled to the mold frame 320, and accommodates therein the optical sheet 330, the light guide plate 340, the light source unit 350, the reflection sheet 360, and the like. The bottom chassis 370 maintains the overall framework of the display device and protects various components accommodated therein.

The bottom chassis 370 may include a back surface portion 371, a side wall portion 372 extending substantially perpendicularly from the back surface portion 371, and the protrusion portion 373 protruding outwardly from the side wall portion 372.

The protrusion portion 373 may be inserted into the coupling groove 325h of the mold frame 320 so that the mold frame 320 and the bottom chassis 370 may be coupled to each other. However, the inventive concept is not limited thereto, and the mold frame 320 and the bottom chassis 370 may be coupled to each other using various methods known in the pertinent art.

The bottom chassis 370 may include or be formed of a metal material having good rigidity and heat dissipation characteristics. In an exemplary embodiment of the inventive concept, the bottom chassis 370 may include at least one of stainless steel, aluminum, an aluminum alloy, magnesium, a magnesium alloy, copper, a copper alloy, or an electrogalvanized steel sheet.

An adhesive tape 384 may be disposed inside the side wall portion 372 of the bottom chassis 370 so as to couple the bottom chassis 370 and the light source substrate 355 with each other. In addition, an adhesive tape 381 may be disposed at the back surface portion 371 of the bottom chassis 370 so as to couple the bottom chassis 370, the reflection sheet 360, and the light guide plate 340. Accordingly, the optical sheet 330, the light guide plate 340, and the reflection sheet 360 may be fixed into a curved surface by the bottom chassis 370 and the mold frame 320, which are curved. The adhesive tapes 381 and 384 may be a double-sided tape, and may be a black tape for substantially preventing light leakage.

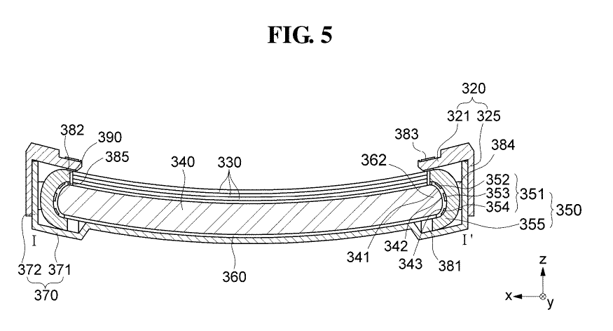

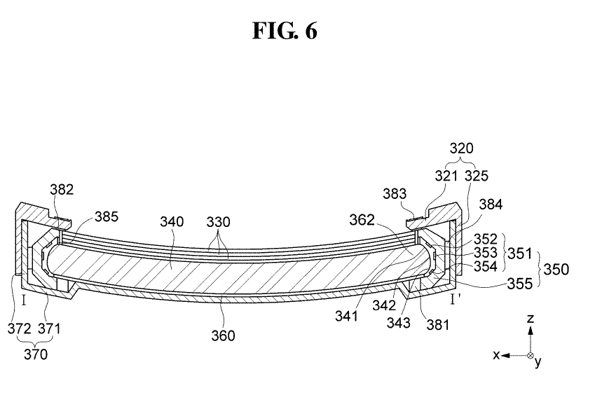

Hereinafter, exemplary embodiments of the inventive concept will be described with reference to FIGS. 5 and 6. For ease of description, the description of configurations substantially the same as those described above will be omitted.

FIG. 5 is a cross-sectional view schematically illustrating a display device according to an exemplary embodiment of the inventive concept.

Referring to FIG. 5, the light source unit 350 of the display device according to an exemplary embodiment of the inventive concept includes the light source 351 and the light source substrate 355. The light guide plate 340 includes a side surface which is curved. The light source substrate 355 has a curvature which is substantially equal to or corresponding to a curvature of the curved light guide plate 340.

The light source 351 includes a first light source 352, a second light source 353, and a third light source 354. The curved light guide plate 340 includes an upper portion 341, an intermediate portion 342, and a lower portion 343. The first light source 352 faces the upper portion 341 to emit light, the second light source 353 faces the intermediate portion 342 to emit light, and the third light source 354 faces the lower portion 343 to emit light. The first light source 352, the second light source 353 and the third light source 354 may all emit white light, or the first light source 352 may emit red light, the second light source 353 may emit blue light, and the third light source 354 may emit green light. Alternatively, the first light source 352 may emit green light, the second light source 353 may emit blue light, and the third light source 354 may emit red light.

Curvatures of the upper portion 341, the intermediate portion 342, and the lower portion 343 may be substantially equal to one another. Alternatively, the curvature of the intermediate portion 342 may be different from the curvatures of the upper portion 341 and the lower portion 343.

The adhesive tape 384 may be disposed between the light source substrate 355 and the side wall portion 372 of the bottom chassis 370 so as to fix the light source substrate 355. In addition, the adhesive tape 382 may be disposed so as to couple the light source substrate 355, the optical sheet 330, and the mold frame 320. In addition, an adhesive tape 385 may be disposed so as to couple the curved light guide plate 340 and the light source substrate 355 with each other. The adhesive tapes 382, 384, and 385 may be a double-sided tape.

With the above-described structure, a light mixing unit 362 generates white light. In addition, since the light source substrate 355 is curved with a curvature substantially the same as a curvature of the side surface of the curved light guide plate 340 and the light source is disposed on the light source substrate 355, the loss of light incident to the light guide plate 340 due to the curved surface on the lateral side of the curved light guide plate 340 may be reduced.

In an exemplary embodiment of the inventive concept, the light source substrate 355 includes a light leakage preventing unit 390 for substantially preventing light from leaking out of the curved light guide plate 340. The light leakage preventing unit 390 may be coupled to the curved light guide plate 340 by the adhesive tape 385.

FIG. 6 is a cross-sectional view schematically illustrating a display device according to an exemplary embodiment of the inventive concept.

Referring to FIG. 6, the light source 351 according to an exemplary embodiment of the inventive concept includes the first light source 352, the second light source 353, and the third light source 354. The curved light guide plate 340 includes the upper portion 341, the intermediate portion 342, and the lower portion 343. The first light source 352 faces the upper portion 341 to emit light, the second light source 353 faces the intermediate portion 342 to emit light, and the third light source 354 faces the lower portion 343 to emit light.

The first light source 352, the second light source 353 and the third light source 354 may all emit white light, or the first light source 352 may emit red light, the second light source 353 may emit blue light, and the third light source 354 may emit green light. Alternatively, the first light source 352 may emit green light, the second light source 353 may emit blue light, and the third light source 354 may emit red light.

In an exemplary embodiment of the inventive concept, an angle formed between a first inclined surface and a second inclined surface of the light source substrate 355 is an obtuse angle, and an angle formed between the second inclined surface and a third inclined surface of the light source substrate 355 is an obtuse angle. The light source substrate 355 has interfacial angles corresponding to a side surface of the curved light guide plate 340. For example, in FIG. 6, the light source substrate 355 has three interfacial angles. The number of interfacial angles may be three or more corresponding to the side surface of the curved light guide plate 340.

With the above-described structure, the light mixing unit 362 generates white light. In addition, since the light source 351 is increased three times or more as compared with a conventional one, the loss of light incident to the light guide plate 340 due to the curved surface on the lateral side of the curved light guide plate 340 may be reduced.

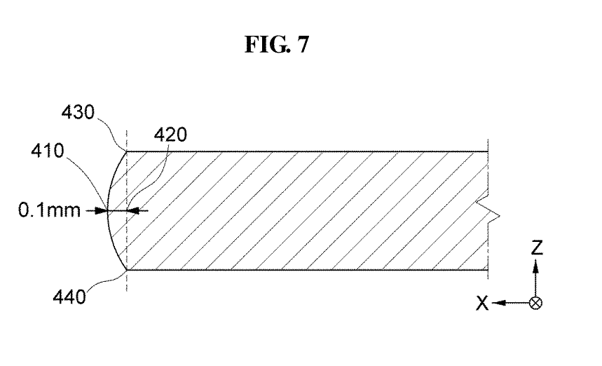

FIG. 7 is a cross-sectional view illustrating a part of a glass light guide plate according to an exemplary embodiment of the inventive concept. Referring to FIG. 7, a thickness of the glass light guide plate is a distance between an upper surface 430 and a lower surface 440. As used herein, a thickness direction (e.g., a Z-axis direction) is a direction between the upper surface 430 and the lower surface 440. The glass light guide plate has at least one side surface protruding in a direction substantially perpendicular to the thickness direction. The side surface of the glass light guide plate protrudes away from the upper surface 430 of the glass light guide plate toward a central portion 420 of the glass light guide plate, and protrudes most at the central portion 420. Accordingly, the side surface of the glass light guide plate has a constant curvature. As used herein, a protruding distance is a distance of a protrusion of the glass light guide plate at the central portion 420. For example, the protruding distance is a distance of a protruding point 410 of the glass light guide plate at the central portion 420 of the glass light guide plate, which is the center in the thickness direction of the glass light guide plate.

When the side surface of the glass light guide plate is subjected to abrasive blasting and thus has a constant curvature, micro cracks which extend from the side surface toward the central portion may be reduced in the glass light guide plate.

In the case where a side portion of the glass light guide plate is chamfered, a number of micro cracks occur at the corner portions. However, when the side portion of the glass light guide plate is processed into a curved surface, the area where micro cracks are generated is reduced to upper and lower end portions of the side surface of the glass light guide plate, and thus the area where the micro cracks may occur may be substantially minimized.

In an exemplary embodiment of the inventive concept, the protruding distance may be about 0.1 mm, or may be about 0.05 mm, about 0.2 mm, or about 0.3 mm. In the case of the curved display device, the side surface of the glass light guide plate may be processed into a curved surface by adjusting the protruding distance of the side surface of the glass light guide plate according to a degree of the curvature of the long sides or the short sides of the glass light guide plate. In other words, when the curvature of the long sides or the short sides of the glass light guide plate is relatively large, a height of the curved surface on a lateral side of the glass light guide plate, e.g., the protruding distance, may be increased. On the other hand, when the curvature of the long sides or the short sides of the glass light guide plate is relatively small, the height of the curved surface on the lateral side of the glass light guide plate, e.g., the protruding distance, may be reduced.

When the side surface of the glass light guide plate is processed into a curved surface, all side surfaces of the glass light guide plate may be processed into a curved surface, or only one side to three sides may be processed into a curved surface.

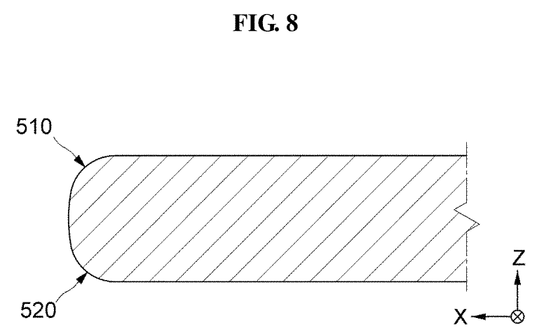

FIG. 8 is a cross-sectional view schematically illustrating a display device according to an exemplary embodiment of the inventive concept.

Referring to FIG. 8, after the side surface of a curved light guide plate is processed into a curved surface, an upper end portion 510 and a lower end portion 520 of the side surface of the curved light guide plate may be further processed into a curved surface. In other words, the upper and lower end portions of the side surface of the curved light guide plate may be processed into a curved surface having a radius R. When the upper and lower end portions of the side surface of the curved light guide plate are further processed into a curved surface having the radius R, micro cracks that may occur at the upper and lower end portions of the side surface of the curved light guide plate may be reduced.

In an exemplary embodiment of the inventive concept, only one of the upper end portion or the lower end portion of the side surface of the curved light guide plate may be processed into a curved surface.

In addition, a curvature applied to the upper end portion 510 and the lower end portion 520 may be in a specific relationship with a curvature applied to the side surface of the curved light guide plate. For example, the radius of curvature applied to the upper end portion 510 and the lower end portion 520 may be about 1/10 or less of the radius of curvature applied to the side surface of the curved light guide plate.

Furthermore, the side surface of the curved light guide plate may have a variable curvature, rather than having a constant curvature.

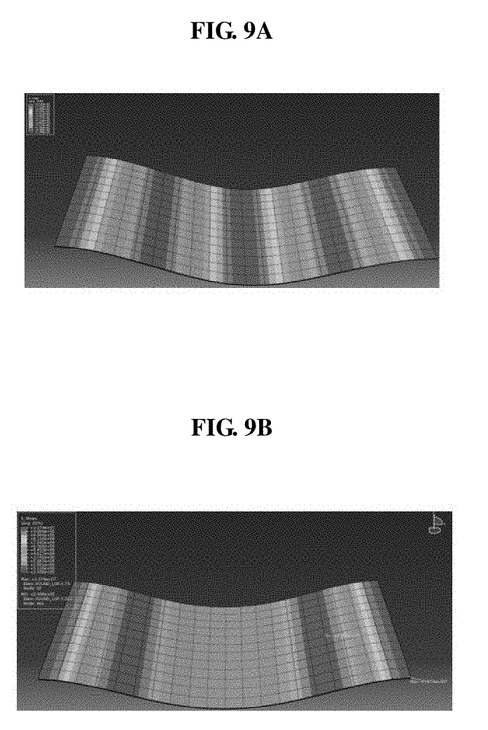

FIGS. 9A and 9B are views illustrating a stress distribution of the light guide plate before and after processing the side surface of the curved light guide plate according to an exemplary embodiment of the inventive concept.

In curved display devices, when the light guide plate is curvedly processed, a stress is generated in the light guide plate.

FIG. 9A is a view illustrating a stress distribution of a case where the light guide plate is processed in a curved manner while the side surface of the curved light guide plate is not processed into a curved surface. A red part is the part where the stress is concentrated, and a blue part is the part where the stress is the weakest. Referring to FIG. 9A, when the light guide plate is processed in a curved manner while the side surface of the curved light guide plate is not processed into a curved surface, stress is intensively generated at the central portion, thus increasing the risk of breakage of the light guide plate.

FIG. 9B is a view illustrating a stress distribution of a case where the light guide plate is processed in a curved manner while the side surface of the curved light guide plate is also processed into a curved surface. When the side surface of the curved light guide plate is processed into a curved surface, although substantially the same force is applied to the light guide plate, the stress on the central portion of the light guide plate is dispersed due to the curved surface on the lateral side of the light guide plate. As can be seen in FIG. 9B, the stress concentrated at the central portion is dispersed.

When the side surface of the curved light guide plate is processed into a curved surface, a chamfered area increases by about 5% or less of a planar area of the side surface.

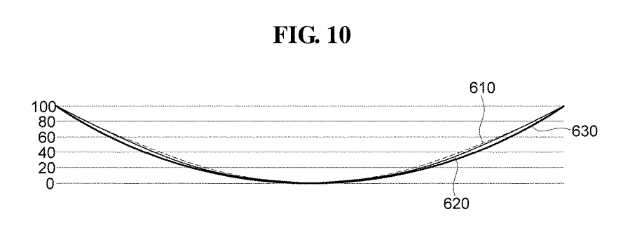

FIG. 10 is a view illustrating the relationship between a shape of the processed side surface and methods of curving surfaces according to an exemplary embodiment of the inventive concept.

Referring to FIG. 10, methods of curving surfaces of a light guide plate in curved display devices may be classified into a sine function curve method 610, a variable curvature method 620, and a constant curvature method 630.

The sine function curve method 610 or the variable curvature method 620 may be largely used because the stress is concentrated at the central portion in the constant curvature method 630. In the variable curvature method 620, the central portion is curvedly formed and other portions are connected thereto with a straight line. In the variable curvature method 620, the stress is concentrated at portions where the curved line and the straight line are connected. The sine function curve method 610 does not generate a portion where the stress is largely concentrated because the stress is distributed thereacross. Although the sine function curve method 610 or the variable curvature method 620 has been used as a method of implementing curved display devices because the stress is not concentrated at the central portion, the curvature formed through the sine function curve method 610 or the variable curvature method 620 is relatively gentle and less than the curvature formed through the constant curvature method 630. The constant curvature method 630 substantially reflects the actual curvature, and may provide greater immersion and a better viewing experience for users. According to exemplary embodiments of the inventive concept, it is possible to implement the curved display devices through the constant curvature method 630 by processing the side surface of the curved light guide plate into a curved surface to disperse the stress concentrated at the center, as described above.

In an exemplary embodiment of the inventive concept, the protruding distance of the curved surface on the lateral side of the light guide plate may vary depending on the degree of curvature. The curvature of the screen becomes smaller as the size of the screen increases, and thus a display device having a relatively small curvature may have a relatively small protruding distance for the curved surface on the lateral side of the light guide plate. On the other hand, the curvature of the screen becomes larger as the size of the screen decreases, and thus a display device having a relatively large curvature may have a relatively large protruding distance for the curved surface on the lateral side of the light guide plate. In other words, the protruding distance of the curved surface on the lateral side of the light guide plate is proportional to the curvature of the light guide plate.

As an example, with respect to a light guide plate having a thickness of about 1.5 mm, the protruding distance of the curved surface on the lateral side of the light guide plate may be about 0.1 mm in a large-sized television that has a radius of curvature of about 4200 mm, and the protruding distance of the curved surface on the lateral side of the light guide plate may be about 0.2 mm in a small-sized television that has a radius of curvature of about 1800 mm. As another example, the protruding distance of the curved surface on the lateral side of the light guide plate may be about 0.1 mm in a monitor that has a radius of curvature of about 4200 mm, and the protruding distance of the curved surface on the lateral side of the light guide plate may be about 0.2 mm in a monitor that has a radius of curvature of about 1800 mm.

When the protruding distance of the curved surface on the lateral side of the light guide plate is about 0.1 mm in a television that has a radius of curvature of about 4200 mm, a ratio of the radius of curvature to the protruding distance may be about 42000. In addition, when the protruding distance of the curved surface on the lateral side of the light guide plate is about 0.2 mm in a television that has a radius of curvature of about 1800 mm, a ratio of the radius of curvature to the protruding distance may be about 9000.

Moreover, in the light guide plate, four side surfaces of the light guide plate may be processed into a curved surface, or only a part of the side surfaces may be processed into a curved surface. In other words, only some side surfaces of the four side surfaces of the light guide plate may be processed in consideration of a luminous efficiency of the light guide plate. As such, one surface to four surfaces on the lateral side of the light guide plate may be processed into a curved surface.

The side surface of the glass light guide plate may be processed by a method of grinding (e.g., abrasive blasting) or cutting. Further, the glass light guide plate may be processed using an edge grinding method due to the characteristics of the glass light guide plate, which is not easy to process.

As set forth hereinabove, according to exemplary embodiments of the inventive concept, the display device including a light guide plate in which the side surface is curvedly formed may reduce cracks of the light guide plate and substantially prevent deformation of the light guide plate.

While the inventive concept has been illustrated and described with reference to exemplary embodiments thereof, it will be apparent to those of ordinary skill in the art that various changes in form and details may be made thereto without departing from the spirit and scope of the inventive concept as set forth by the following claims.

What is claimed is:

1. A display device comprising:
a curved display panel;
a light source configured to emit a light; and
a curved light guide plate having a curvature corresponding to a curvature of the curved display panel and configured to emit the light incident from the light source to the curved display panel,
wherein the curved display panel and the curved light guide plate are disposed in a first direction,
the curved light guide plate comprises a side surface which protrudes in a direction substantially perpendicular to the first direction,
the side surface protrudes away from an upper surface of the curved light guide plate toward a central portion of the curved light guide plate, and
the side surface has a protruding distance proportional to the curvature of the curved light guide plate.

2. The display device of claim 1, wherein a ratio of a radius of the curvature of the curved light guide plate to the protruding distance is about 9000 or more and 42000 or less.

3. The display device of claim 1, wherein the curved light guide plate is a glass light guide plate.

4. The display device of claim 1, wherein the side surface of the curved light guide plate comprises one to four protruding side surfaces.

5. The display device of claim 1, wherein the side surface of the curved light guide plate has a constant curvature.

6. The display device of claim 1, wherein the side surface of the curved light guide plate has a variable curvature.

7. A display device comprising:
a curved display panel;
a light source configured to emit a light;
a light source substrate on which the light source is disposed; and
a curved light guide plate having a curvature corresponding to a curvature of the curved display panel and configured to emit the light incident from the light source to the curved display panel,
wherein the curved display panel, the light source substrate and the curved light guide plate are disposed in a first direction,
the curved light guide plate comprises a side surface which protrudes in a direction substantially perpendicular to the first direction,
the side surface protrudes away from an upper surface of the curved light guide plate toward a central portion of the curved light guide plate, and
the side surface has a protruding distance proportional to the curvature of the curved light guide plate, and
the light source substrate has a curvature corresponding to the curvature of the curved light guide plate.

8. The display device of claim 7, wherein a ratio of a radius of the curvature of the curved light guide plate to the protruding distance is about 9000 or more and 42000 or less.

9. The display device of claim 7, wherein the curved light guide plate is a glass light guide plate.

10. The display device of claim 7, wherein the side surface of the curved light guide plate comprises one to four protruding side surfaces.

11. The display device of claim 7, wherein the side surface of the curved light guide plate has a constant curvature.

12. The display device of claim 7, wherein the side surface of the curved light guide plate has a variable curvature.

13. A display device comprising:
a curved display panel;
a light source configured to emit a light;
a light source substrate on which the light source is disposed; and
a curved light guide plate having a curvature corresponding to a curvature of the curved display panel and configured to emit the light incident from the light source to the curved display panel,
wherein the curved display panel, the light source substrate and the curved light guide plate are disposed in a first direction,
the curved light guide plate comprises a side surface which protrudes in a direction substantially perpendicular to the first direction,
the side surface protrudes away from an upper surface of the curved light guide plate toward a central portion of the curved light guide plate,
the side surface has a protruding distance proportional to the curvature of the curved light guide plate, and
the light source substrate has an interfacial angle corresponding to the side surface of the curved light guide plate.

14. The display device of claim 13, wherein a ratio of a radius of the curvature of the curved light guide plate to the protruding distance is about 9000 or more and 42000 or less.

15. The display device of claim 13, wherein the curved light guide plate is a glass light guide plate.

16. The display device of claim 13, wherein the side surface of the curved light guide plate comprises one to four protruding side surfaces.

17. The display device of claim 13, wherein the side surface of the curved light guide plate has a constant curvature.

18. The display device of claim 13, wherein the side surface of the curved light guide plate has a variable curvature.

19. A curved light guide plate having a curvature corresponding to a curvature of a curved display panel, configured to emit a light incident from a light source to the curved display panel, and comprising a side surface which protrudes in a direction substantially perpendicular to a first direction,
wherein the curved light guide plate and the curved display panel are disposed in the first direction,
the side surface protrudes away from an upper surface of the curved light guide plate toward a central portion of the curved light guide plate, and
the side surface has a protruding distance proportional to the curvature of the curved light guide plate.

20. The curved light guide plate of claim 19, wherein a ratio of a radius of the curvature of the curved light guide plate to the protruding distance is about 9000 or more and 42000 or less.

21. The curved light guide plate of claim 19, wherein the curved light guide plate is a glass light guide plate.

22. The curved light guide plate of claim 19, wherein the side surface of the curved light guide plate comprises one to four protruding side surfaces.

23. The curved light guide plate of claim 19, wherein the side surface of the curved light guide plate has a constant curvature.

24. The curved light guide plate of claim 19, wherein the side surface of the curved light guide plate has a variable curvature.

25. A method of forming a display device including a curved display panel and a light guide plate, the method comprising:
processing the light guide plate to have a curvature corresponding to a curvature of the curved display panel; and
processing a side surface of the light guide plate to have a curvature and protrude away from an upper surface of the light guide plate towards a central portion of the light guide plate,
wherein the side surface has a protruding distance proportional to the curvature of the light guide plate.

26. The method of claim 25, wherein the light guide plate is processed using a constant curvature method.

27. The method of claim 25, further comprising:
processing an upper end portion and a lower end portion of the side surface to have a curvature,
wherein a radius of the curvature of the upper end portion and the lower end portion is about 1/10 or less of a radius of the curvature of the side surface.

28. The method of claim 25, wherein when the side surface of the light guide plate is processed to have a curvature, a chamfered area of the side surface increases by about 5% or less of a planar area of the side surface.

29. The method of claim 25, wherein a ratio of a radius of the curvature of the light guide plate to the protruding distance is about 9000 or more and 42000 or less.

30. The method of claim 25, wherein the light guide plate is a glass light guide plate.

31. The method of claim 25, wherein the side surface of the light guide plate comprises one to four protruding side surfaces.

32. The method of claim 25, wherein the side surface of the light guide plate has a constant curvature.

33. The method of claim 25, wherein the side surface of the light guide plate has a variable curvature.
